(19) United States
(12) Patent Application Publication
(10) Pub. No.: US 2012/0268776 A1
(43) Pub. Date: Oct. 25, 2012

(54) MOBILE PHONE AND METHOD FOR COPYING AND PROCESSING DATA

(75) Inventor: SHENG-HSIEN CHEN, Tu-Cheng (TW)

(73) Assignee: CHI MEI COMMUNICATION SYSTEMS, INC., Tu-Cheng (TW)

(21) Appl. No.: 13/337,121

(22) Filed: Dec. 25, 2011

(30) Foreign Application Priority Data
Apr. 25, 2011 (TW) 100114191

(51) Int. Cl. G06K 15/02; H04W 88/02; G06F 3/041

(52) U.S. Cl. 358/1.15; 455/556.1

(57) ABSTRACT

A method for copying and processing a desired part selected from a display on a touch screen of a mobile phone marks the selected part and receives a processing mode for processing the marked part. The method copies the marked part and stored the marked part as a temporary image document in a storage unit of the mobile phone. The method processes the temporary image document according to the processing mode selected.

### BACKGROUND

1. Technical Field

Embodiments of the present disclosure generally relate to data processing technology, and more particularly to a mobile phone and a method for copying and processing data selected from a display on a touch screen of the mobile phone.

2. Description of Related Art

When a user wants to transmit or print part of the information in a document (e.g., a web page or a photo) displayed on a screen of a mobile phone, the user has to connect the mobile phone to a computing device, and transmit the document to the computing device first. Then, the user may process the document using file editing software, optical character recognition software, or drawing software, to extract required information from the document, and transmit or print the required information.

### BRIEF DESCRIPTION OF THE DRAWINGS

FIG. 1 is a block diagram of one embodiment of a mobile phone including a copying and processing unit for copying and processing data selected from a display on a touch screen of the mobile phone.

FIG. 2 is a block diagram of one embodiment of function modules of the copying and processing unit.

FIG. 3 is a flowchart of one embodiment of a method for copying and processing data selected from a display on a touch screen of the mobile phone.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

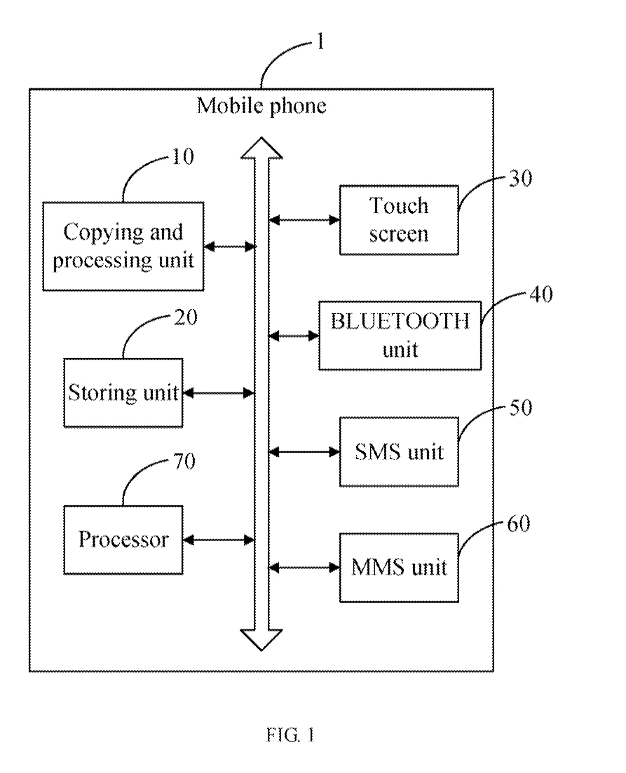

FIG. 1 is a block diagram of one embodiment of a mobile phone 1 including a copying and processing unit 10 for copying and processing data selected from a display on a touch screen 30 of the mobile phone 1. The mobile phone 1 further includes a storage unit 20, a BLUETOOTH unit 40, a short message service (SMS) unit 50, a multimedia messaging service (MMS) unit 60, and a processor 70.

When a user accesses the Internet by means of the mobile phone 1 or reads a document (such as a web page or a photo) in the mobile phone 1, the user can select part of the information (such as an image or certain characters) from the document displayed on the touch screen 30 by touching the touch screen 30. The copying and processing unit 10 marks the selected part in the document, and copies and processes the marked part.

The storage unit 20 stores the marked part.

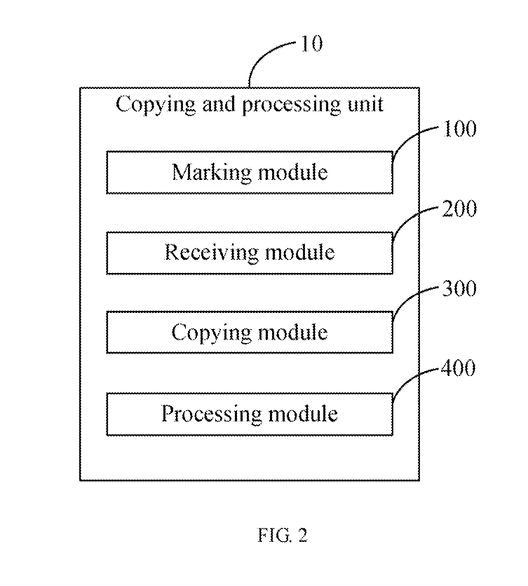

In one embodiment, the copying and processing unit 10 may include one or more function modules (a description is given in FIG. 2). The one or more function modules may comprise computerized code in the form of one or more programs that are stored in the storage unit 20, and executed by the processor 70 to provide the functions of the copying and processing unit 10. The storage unit 20 may be a cache or a dedicated memory, such as an EPROM or a flash memory.

FIG. 2 is a block diagram of one embodiment of the function modules of the copying and processing unit 10. In one embodiment, the copying and processing unit 10 includes a marking module 100, a receiving module 200, a copying module 300, and a processing module 400.

The marking module 100 is operable to mark part of a document displayed on the touch screen 30 that is selected by a user. In one embodiment, the marking module 100 analyzes the coordinates of one or more touch points when the finger(s) of a user is applied to the touch screen 30 to select a part of the document, then marks or highlights the selected part of the document with an outline or a shadow.

The receiving module 200 is operable to receive a processing mode for processing the marked part selected by the user. In one embodiment, when the selected part is marked, one or more processing mode that allows for processing the marked part are displayed on the touch screen 30. The user can touch one of the processing modes to select a desired processing mode for processing the marked part. The processing modes may include: a printing mode, a transmitting the marked part as an image document mode, a transmitting the marked part as a short message mode, or a transmitting the marked part as a multimedia message mode. Other processing modes for processing the marked part(s) may exist in other embodiments.

The copying module 300 is operable to copy the marked part and store the marked part as a temporary image document in the storage unit 20. In one embodiment, a type of the temporary image document may be a bitmap (BMP) or JPEG format.

The processing module 400 is operable to process the temporary image document according to the processing mode selected. The processing procedure may include:

If the user selects the printing mode, the processing module 400 transmits the temporary image document to a printer through the BLUETOOTH unit 40 using BLUETOOTH personal area network (PAN) technology.

If the user selects the transmitting the marked part as an image document mode, the processing module 400 transmits the temporary image document to the BLUETOOTH unit 40, then the BLUETOOTH unit 40 may transmit the temporary image document to a selected other mobile phone equipped with BLUETOOTH file transfer protocol (FTP) technology.

If the user selects the transmitting the marked part as a short message mode, the processing module 400 reads the characters from the temporary image document using optical character recognition software in the mobile phone 1, and allows any editing required, then transmits the short message through the SMS unit 50.

If the user selects the transmitting the marked part as a multimedia message mode, the processing module 400 converts the temporary image document into a formal multimedia document, then transmits the formal multimedia document as an enclosure of a multimedia message through the MMS unit 60 after the user has carried out any editing required.

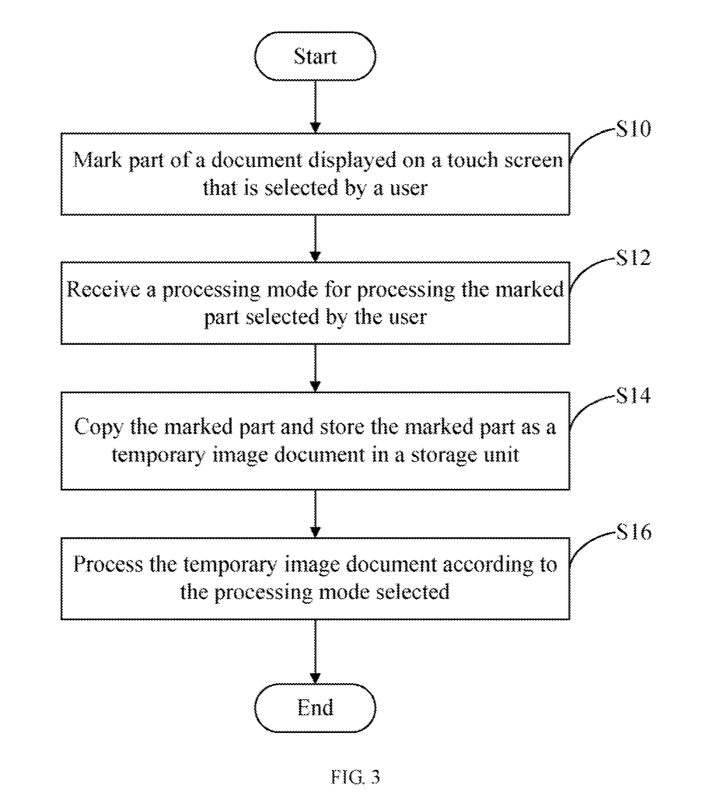

FIG. 3 is a flowchart of one embodiment of a method for copying and processing data selected from a display on a touch screen 30 of the mobile phone 1. Depending on the embodiment, additional steps may be added, others removed, and the ordering of the steps may be changed.

In step S10, the marking module 100 marks part of a document displayed on the touch screen 30 that is selected by a user. In one embodiment, the marking module 100 analyzes the coordinates of one or more touch points when the finger(s) of a user is applied to the touch screen 30 to select a part of the document, then marks or highlights the selected part of the document with an outline or a shadow.

In step S12, the receiving module 200 receives a processing mode for processing the marked part selected by the user.

In step S14, the copying module 300 copies the marked part and stores the marked part as a temporary image document in the storage unit 20.

In step S16, the processing module 400 processes the temporary image document according to the processing mode selected.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A method being processed by a processor of a mobile phone for copying and processing data selected from a display on a touch screen of the mobile phone, the method comprising:
(a) marking part of a document displayed on the touch screen that is selected by a user touching the touch screen;
(b) storing the marked part as a temporary image document in a storage unit of the mobile phone; and
(c) processing the temporary image document according to a selected processing mode from one or more processing modes.

2. The method as claimed in claim 1, wherein the one or more processing modes comprise a printing mode, a transmitting the marked part as an image document mode, a transmitting the marked part as a short message mode, or a transmitting the marked part as a multimedia message mode.

3. The method as claimed in claim 2, wherein the step (d) comprises:
transmitting the temporary image document to a printer through a BLUETOOTH unit of the mobile phone using BLUETOOTH personal area network technology in response that the user selects the printing mode; or
transmitting the temporary image document to the BLUETOOTH unit, and the BLUETOOTH unit transmitting the temporary image document to a selected other mobile phone equipped with BLUETOOTH file transfer protocol technology in response that the user selects the transmitting the marked part as an image document mode; or
reading characters from the temporary image document using optical character recognition software of the mobile phone, and transmitting a short message through a short message service unit of the mobile phone in response that the user selects the transmitting the marked part as a short message mode; or
converting the temporary image document into a formal multimedia document, and transmitting the formal multimedia document as an enclosure of a multimedia message through a multimedia messaging service unit of the mobile phone after the user has carried out any editing required in response that the user selects the transmitting the marked part as a multimedia message mode.

4. The method as claimed in claim 1, wherein the step (a) further comprising:
analyzing coordinates of one or more touch points when finger(s) of a user is applied to the touch screen to select a part of the document, then marking or highlighting the selected part of the document with an outline or a shadow.

5. A non-transitory storage medium storing a set of instructions, the set of instructions capable of being executed by a processor to perform a method for copying and processing data selected from a display on a touch screen of a mobile phone, the method comprising:
(a) marking part of a document displayed on the touch screen that is selected by a user touching the touch screen;
(b) storing the marked part as a temporary image document in a storage unit of the mobile phone; and
(c) processing the temporary image document according to a selected processing mode from one or more processing modes.

6. The non-transitory storage medium as claimed in claim 5, wherein the one or more processing modes comprise a printing mode, a transmitting the marked part as an image document mode, a transmitting the marked part as a short message mode, or a transmitting the marked part as a multimedia message mode.

7. The non-transitory storage medium as claimed in claim 6, wherein the step (d) comprises:
transmitting the temporary image document to a printer through a BLUETOOTH unit of the mobile phone using BLUETOOTH personal area network technology in response that the user selects the printing mode; or
transmitting the temporary image document to the BLUETOOTH unit, and the BLUETOOTH unit transmitting the temporary image document to a selected other mobile phone equipped with BLUETOOTH file transfer protocol technology in response that the user selects the transmitting the marked part as an image document mode; or
reading the characters from the temporary image document using optical character recognition software of the mobile phone, and transmitting a short message through a short message service unit of the mobile phone in response that the user selects the transmitting the marked part as a short message mode; or
converting the temporary image document into a formal multimedia document, and transmitting the formal multimedia document as an enclosure of a multimedia message through a multimedia messaging service unit of the mobile phone after the user has carried out any editing required in response that the user selects the transmitting the marked part as a multimedia message mode.

8. The non-transitory storage medium as claimed in claim 5, wherein the step (a) further comprising:
analyzing coordinates of one or more touch points when finger(s) of a user is applied to the touch screen to select a part of the document, then marking or highlighting the selected part of the document with an outline or a shadow.

9. A mobile phone, the mobile phone comprising:
a storage unit;
a touch screen;
at least one processor; and
one or more programs stored in the storage unit, executable by the at least one processor, the one or more programs comprising:
a marking module operable to mark part of a document displayed on the touch screen that is selected by a user touching the touch screen;
a copying module operable to store the marked part as a temporary image document in the storage unit; and
a processing module operable to process the temporary image document according to a selected processing mode from one or more processing modes.

10. The mobile phone as claimed in claim 9, wherein the one or more processing modes comprise a printing mode, a transmitting the marked part as an image document mode, a transmitting the marked part as a short message mode, or a transmitting the marked part as a multimedia message mode.

11. The mobile phone as claimed in claim 10, wherein the processing module further operable to:
transmit the temporary image document to a printer through a BLUETOOTH unit of the mobile phone using BLUETOOTH personal area network technology in response that the user selects the printing mode; or
transmit the temporary image document to the BLUETOOTH unit, and the BLUETOOTH unit transmit the temporary image document to a selected other mobile phone equipped with BLUETOOTH file transfer protocol technology in response that the user selects the transmitting the marked part as an image document mode; or
read characters from the temporary image document using optical character recognition software of the mobile phone, and transmit a short message through a short message service unit of the mobile phone in response that the user selects the transmitting the marked part as a short message mode; or
convert the temporary image document into a formal multimedia document, and transmit the formal multimedia document as an enclosure of a multimedia message through a multimedia messaging service unit of the mobile phone after the user has carried out any editing required in response that the user selects the transmitting the marked part as a multimedia message mode.

12. The mobile phone as claimed in claim 9, wherein the marking module further operable to:
analyze coordinates of one or more touch points when finger(s) of a user is applied to the touch screen to select a part of the document, then mark or highlight the selected part of the document with an outline or a shadow.
